(19) United States
(12) Patent Application Publication
(10) Pub. No.: US 2026/0300427 A1
(43) Pub. Date: Oct. 1, 2026

(54) RECONFIGURABLE PROCESSING UNITS FOR EFFICIENT SUPPORT OF MULTIPLE POST-QUANTUM CRYPTOGRAPHIC ALGORITHMS

(71) Applicant: CRYPTOGRAPHY RESEARCH, INC., San Jose, CA (US)

(72) Inventors: Michael Alexander Hamburg, Rosmalen (NL); Arvind Singh, Dublin, CA (US); Lauren Kristin De Meyer, San Francisco, CA (US); Simon Hoerder, Eindhoven (NL)

(21) Appl. No.: 19/489,836

(22) PCT Filed: Jun. 5, 2024
(86) PCT No.: PCT/US2024/032633

§ 371 Date: Dec. 3, 2025

Related U.S. Application Data
(60) Provisional application No. 63/471,368, filed on Jun. 6, 2023.

(51) Int. Cl. G06F 17/14; H04L 9/30

(52) U.S. Cl. CPC G06F 17/142; H04L 9/3093

(57) ABSTRACT

Disclosed aspects and implementations are directed to devices and techniques for performing cryptographic operations using post-quantum algorithms. Reconfigurable processing devices supports multiple algorithms that deploy various integer and polynomial arithmetic operations including Number Theoretic Transforms, inverse Number Theoretic Transforms, pointwise polynomial multiplications, pairwise polynomial multiplications, pointwise-pairwise polynomial multiplications, Karatsuba multiplications, and/or other operations. The reconfigurable processing device(s) may be integrated into a streaming pipeline that includes a hash value generator and a sampler with matching throughputs for efficient utilization of computational and memory resources.

### CLAIM OF PRIORITY

This application is a National Stage of International Application No. PCT/US24/32633, filed Jun. 5, 2024, which claims the benefit under 35 U.S.C. § 119 (e) of U.S. Provisional Patent Application No. 63/471,368 filed Jun. 6, 2023, both the aforementioned applications being incorporated by reference in their entirety herein.

### TECHNICAL FIELD

Aspects of the present disclosure are directed to performing lattice-based post-quantum cryptographic algorithms.

### BRIEF DESCRIPTION OF THE DRAWINGS

The present disclosure will be understood more fully from the detailed description given below and from the accompanying drawings of various implementations of the disclosure.

FIG. 1 is a block diagram illustrating an example system architecture deploying reconfigurable processing devices and techniques capable of supporting a diverse set of polynomial-based cryptographic applications, in accordance with one or more aspects of the present disclosure.

FIGS. 2A-2C depict one example reconfigurable processing unit capable of supporting multiple cryptographic algorithms, in accordance with one or more aspects of the present disclosure. FIG. 2A illustrates an architecture of the processing unit. FIG. 2B illustrates configuration and operations of the processing unit of FIG. 2A during execution of the Cooley-Tukey algorithm. FIG. 2C illustrates configuration and operations of the processing unit of FIG. 2A during execution of the Gentlemen-Sande algorithm.

FIG. 3 illustrates deployment of a processing unit for Kyber polynomial multiplication using the Karatsuba algorithm, in accordance with one or more aspects of the present disclosure.

FIGS. 4A-4C illustrate deployment of the processing unit of FIG. 3 as a Dilithium-type multiplication unit, in accordance with one or more aspects of the present disclosure. FIGS. 4D and 4E illustrate deployment of the processing units of FIG. 3 for Dilithium NTT butterfly operations, in accordance with one or more aspects of the present disclosure.

FIG. 5A illustrates operations of three first Cooley-Tukey NTT iterations applied to a portion having eight elements, in accordance with one or more aspects of the present disclosure.

FIG. 5B depicts schematically the last three iterations of Kyber NTT (or inverse NTT) for which operations of the three-iteration fused processing illustrated may be used, in accordance with one or more aspects of the present disclosure.

FIG. 6 illustrates one example architecture of a shift register that may be used to support operations of butterfly processing units, in accordance with one or more aspects of the present disclosure.

FIG. 7 depicts an example architecture for streaming support of hash acceleration in lattice-based algorithms, in accordance with one or more aspects of the present disclosure.

FIG. 8 depicts an example architecture of a sampler of FIG. 7 that supports a configurable data path for acceleration of lattice-based algorithms, in accordance with one or more aspects of the present disclosure.

FIG. 9 illustrates an example architecture of a polynomial arithmetic unit that supports, as part of a Hash-Sample-Arithmetic pipeline, a configurable data path for acceleration of lattice-based algorithms, in accordance with one or more aspects of the present disclosure.

FIG. 10 depicts a flow diagram of an example method of deploying reconfigurable processing units, operating in accordance with one or more aspects of the present disclosure, for performance of polynomial-based cryptographic applications.

### DETAILED DESCRIPTION

In public-key cryptography systems, a processing device may have various components/modules used for cryptographic operations on input messages. Input messages used in such operations are often large positive integers. Examples of cryptographic operations include, but are not limited to operations involving Rivest-Shamir-Adelman (RSA), digital signature algorithms (DSA), Diffie-Hellman key exchange (DHKE), Elliptic Curve Cryptography (ECC), and the like. Cryptographic algorithms often involve modular arithmetic operations with modulus q, in which the set of all integers Z is wrapped around a circle of length q (the set Z_{q}), so that any two numbers that differ by q (or any other integer multiple of q) are treated as the same number. Pre-quantum cryptographic applications often exploit the fact that extracting a private key multiplier from a public key product (modulo q) that involves the private key multiplier may be a prohibitively difficult operation on a classical computer.

RSA, DHKE, ECC, and other public key encryption schemes typically rely on the difficulty of solving one of the following three problems: the integer factorization problem, the discrete logarithm problem, or the elliptic curve discrete logarithm problem. However, progress in quantum computing technology has placed conventional public key encryption schemes into jeopardy since these problems can be efficiently solved on a sufficiently powerful quantum computer using the Shor's algorithm. With research on quantum computing advancing rapidly, there is an expectation that the cryptosystems in current use are likely to be broken within the next decade.

In response, in 2016, the National Institute of Standards and Technology (NIST) initiated a Post-Quantum Cryptography (PQC) standardization process to promote development of public-key cryptographic algorithms that are resistant against quantum computers. In July 2022, after rigorous analysis and evaluation, NIST has finalized the following algorithms: CRYSTALS-KYBER (referred to as Kyber herein) key encapsulation mechanism (KEM), CRYSTALS-DILITHIUM digital signatures algorithm (referred to as Dilithium herein), FALCON digital signatures algorithm, and SPHINCS+hash-based signature algorithm. In particular, NIST recommended Dilithium as the primary signature algorithm. Additional KEM algorithms are currently considered, including BIKE, Classic McEliece, and HQC. Further NIST competitions have been initiated for signature algorithms that are based on different mathematical foundations.

While various lattice-based post-quantum cryptographic algorithms, such as Kyber and Dilithium, share some features (e.g., the use of polynomial arithmetic operations), different algorithms use different parameter sets and operate in different modular fields. It is, therefore, challenging to design an efficient polynomial arithmetic hardware unit (processor) that can be fully utilized for multiple lattice-based algorithms. More specifically both Kyber and Dilithium are based on Module-Learning-With-Errors (MLWE) problem on structured lattices with the underlying operations requiring matrix-vector (and vector-vector) multiplications where the elements of the matrices/vectors are polynomials defined on a ring R_{q}=Z_{q} [X]/(Xⁿ+1), namely polynomials having coefficients in Z_{q} with operations defined modulo the irreducible polynomial Xⁿ+1. Polynomial multiplications in R_{q} can be efficiently performed using O(n lg(n)) operations of number theoretic transforms (NTTs), that are analogous to Digital Fourier Transforms. The NTT, being applied to an N-component input polynomial

$$a ( X ) = {\sum }_{i = 0}^{N - 1} {a}_{i} {X}^{i}$$

transforms the input polynomial into an output polynomial

$$NTT ( a ( X ) ) ≡ \hat{a} = {\sum }_{i = 0}^{N - 1} {\hat{a}}_{i} {X}^{i} ,$$

with coefficients

$${\hat{a}}_{i} = {\sum }_{k = 0}^{N - 1} {a}_{k} {W}_{N}^{i k} mod q ,$$

where W_{N} is an Nth primitive root of unity. Multiplication of two polynomials, a(X) and b(X), may be performed by first computing the NTTs of each polynomial, â(X) and \hat{b}(X), and then computing the pointwise multiplication of the two NTTs.

$$\hat{c} ( X ) = {\sum }_{i = 0}^{N - 1} {\hat{c}}_{i} {X}^{i} = {\sum }_{i = 0}^{N - 1} {\hat{a}}_{i} {\hat{b}}_{i} {X}^{i}$$

mod q, followed by computing the inverse NTT (INTT):

$${c}_{i} = \frac{1}{N} {\sum }_{k = 0}^{N - 1} {\hat{c}}_{k} {W}_{N}^{- ik} mod q .$$

The resulting polynomial

$$c ( X ) ≡ {\sum }_{i = 0}^{N - 1} {a}_{i} {X}^{i} = INTT ( NTT ( a ( X ) ) ∘ NTT ( b ( X ) ) )$$

coincides with the product of two polynomials c(X)=a(X)b(X) on R_{q}. This algorithm is directly applicable to Dilithium (since a 512^{th} primitive root for the Dilithium modulus q=8380417 exists) but undergoes some modification for Kyber (as there is no 512^{th} primitive root for the Kyber modulus q=3329). The NTT used by Kyber of polynomial a(X) is a vector of

$$\frac{N}{2} = 128$$

polynomials or (at most) degree 1, â(X)=(â₀+â₁X; â₂+â₃X; . . . ; â₂₅₄+â₂₅₅X), where

$${\hat{a}}_{2 i} = {\sum }_{k = 0}^{N - 1} {a}_{2 k} {W}_{256}^{( 2 br ( i ) + 1 ) j} and {\hat{a}}_{2 i + 1} = {\sum }_{k = 0}^{N - 1} {a}_{2 k + 1} {W}_{256}^{2 br ( i ) + 1} ,$$

with br(i) standing for the bit-reversed digital value of integer i. Instead of computing the pointwise multiplications âᵢ\hat{b}ᵢ, the Kyber step of combining the two NTTs includes computing the pairwise-pointwise polynomial products

$$( {\hat{a}}_{2 j} + {\hat{a}}_{2 j + 1} X ) ( {\hat{b}}_{2 j} + {\hat{b}}_{2 j + 1} X ) mod ( {X}^{2} - {W}_{256}^{2 br ( i ) + 1} ) = {\hat{a}}_{2 j} {\hat{b}}_{2 j} + {W}_{256}^{2 br ( i ) + 1} {\hat{a}}_{2 j + 1} {\hat{b}}_{2 j + 1} + ( {\hat{a}}_{2 j} {\hat{b}}_{2 j + 1} + {\hat{a}}_{2 j + 1} {\hat{b}}_{2 j} ) X .$$

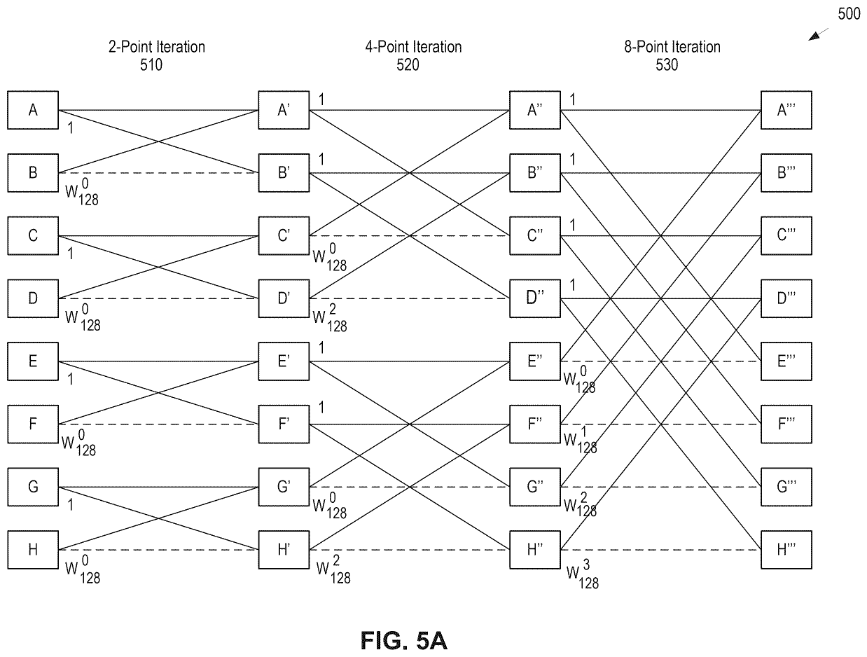

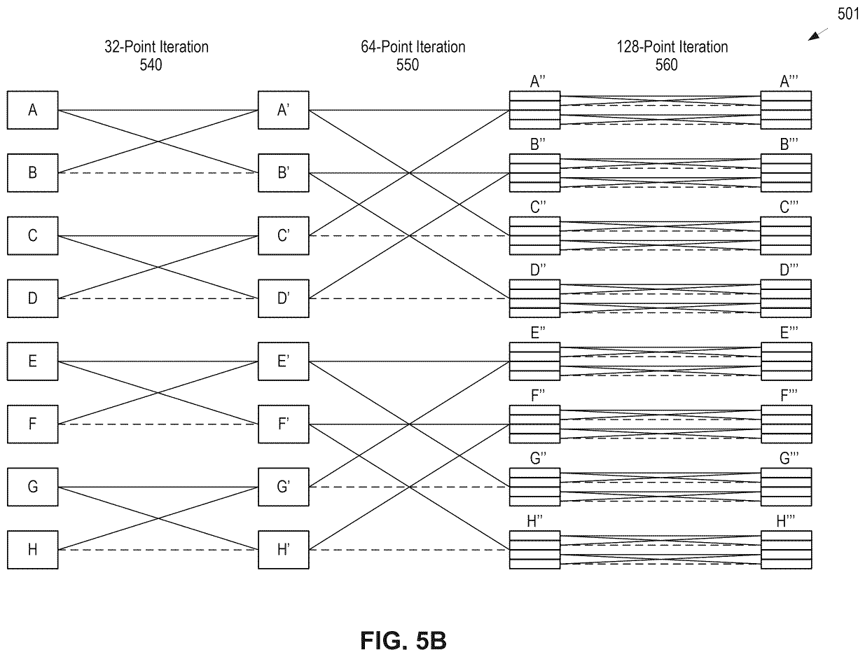

A Fast NTT (which is similar to a Fast Fourier Transform) computes N/2 2-point butterfly transforms in each of log₂ N iterations. Essentially, a fast NTT amounts to computing N/2 2-point transforms in the first iteration followed by computing N/4 4-point transforms in the second iteration, and so on, until the last iteration produces the ultimate N-point NTT, e.g., as illustrated in more detail with reference to FIG. 5A below. Different groupings of input elements into each iteration may be used. Grouping even elements with adjacent odd elements gives rise to Cooley-Tukey butterfly operations, where two input elements into a particular iteration, A and B, are transformed into the output elements according to:

$$A , B \to {A}^{′} = A + B \cdot {W}_{N}^{i} , {A}^{′} = A - B \cdot {W}_{N}^{i} .$$

Grouping elements from a first half of elements with corresponding elements from a second half gives rise to Gentleman-Sande butterfly operations, where input elements are transformed into the output elements according to:

$$A , B \to {A}^{′} = A + B , {B}^{′} = ( A - B ) \cdot {W}_{N}^{i} .$$

Often, the Cooley-Tukey algorithm is used for the forward NTTs and the Gentleman-Sande is used for the inverse NTTs.

Even though both Kyber and Dilithium deploy NTTs that can be implemented using similar techniques, specific differences (such as differences in bit size of the base field) can make processing circuits designed for one of the two algorithms sub-optimal for the other algorithm. For example, Kyber uses the irreducible polynomial X²⁵⁶+1 (N=256) and modulus q=13×2⁸+1=3329. Because a 2N-th primitive root of unity does not exist but N-th primitive root of unity does exist, the Kyber algorithm involves performing two 128-point NTTs (in lieu of one 256-point NTT). This involves factoring the irreducible polynomial X²⁵⁶+1 into 128 polynomials of degree two and computing the NTT as a vector of 128 polynomials of degree one,

$$a ( x ) mod ( {X}^{2} - {W}_{256}^{2 br ( i ) + 1} ) ,$$

for i=0, . . . , 127. The NTT vector is then obtained using one of the butterfly techniques, e.g., Cooley-Tukey techniques. Polynomial multiplications performed in the NTT domain are pairwise-pointwise multiplications. In contrast, Dilithium uses the base field with q=2²³−2¹³+1=8380417, 2N-th primitive root of unity exists and, therefore, multiplications are pointwise (but not pairwise). Furthermore, Dilithium operates on longer words (23-bit words) than Kyber (12-bit words).

Aspects and implementations of the present disclosure address these and other challenges of the modern post-quantum cryptography by disclosing processing devices and techniques that fully leverage computation hardware for multiple algorithms by supporting NTTs, inverse NTTs, and various polynomial multiplication operations. The disclosed hardware is reconfigurable to support a specific algorithm being executed (of multiple supported algorithms), including but not limited to Kyber and Dilithium algorithms. In one example implementation, the disclosed processing device includes four butterfly processing units (also referred to as butterfly units herein) that can be selectively reconfigured into the Cooley-Tukey butterflies or the Gentleman-Sande butterflies, e.g., to implement the forward or inverse NTT, respectively. A butterfly processing unit may have a multiplication circuit, e.g., a multiplication circuit with modular reduction to support modular multiplications. The butterfly processing unit may further include multiple addition circuits and multiple subtraction circuits. Some of the addition and/or subtraction circuits may be active in some configurations and inactive in others. The disclosed processing device may also include a memory unit that may include a scratchpad memory that allows a read operation and a write operation per one processing cycle. The read/write operation may retrieve/store a 64-bit word from/to the scratchpad memory. The memory unit may further include a Random Access Memory (RAM) allowing a 64-bit read operation or a 64-bit write operation per cycle. The RAM may store variable data and fixed values that are used in NTT (and inverse NTT) operations, e.g., powers of W_{N} (twiddle factors), also denoted via ζ herein. Such constants maybe stored in bit-reversed form, e.g., ζ^{br7(i)}. Individual 64-bit words stored in the memory (scratchpad and/or RAM) may include four 12-bit Kyber polynomial coefficients (each rounded to 16 bits) or two 24-bit Dilithium polynomial coefficients (each rounded to 32 bits). In some implementations, multiple iterations of NTT (e.g., two or three iterations, as described in more detail below) may be merged (fused) together, to reduce the memory bandwidth and increase utilization of processing (butterfly) units.

The disclosed processing device may support up to 4 butterfly operations (or 4 modular multiplications) per cycle for Kyber and up to 1 butterfly operation (or 1 modular multiplication) per cycle for Dilithium. Scaling up the disclosed devices may enable, correspondingly, parallel computation of 4× Kyber butterflies and 1× computation of Dilithium butterflies. Furthermore, as disclosed herein, the processing device may be configured to implement Kyber pairwise-pointwise polynomial operations via Karatsuba multiplication, and/or other types of multiplication operations.

Numerous additional implementations are disclosed herein. The advantages of the disclosed implementations include, but are not limited to flexible and efficient execution of a variety of post-quantum cryptographic algorithms. The disclosed implementations may be used in public key cryptography, symmetric key cryptography, digital signature algorithms, and/or various other systems that deploy polynomial operations. The disclosed implementations may be used to support a broad range of vector and matrix operations, including (but not limited to) vector and matrix computations involving integer polynomials (e.g., as used in the Kyber and Dilithium algorithms).

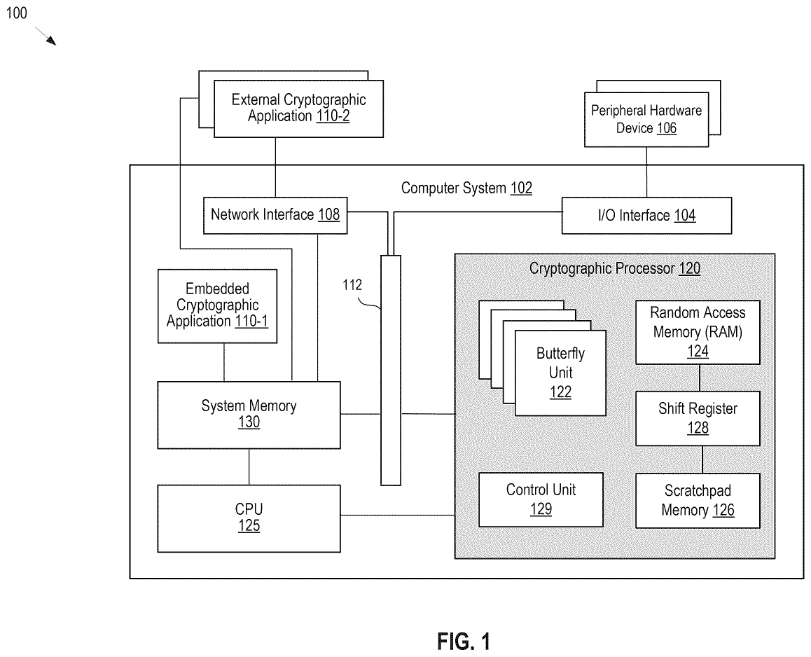

FIG. 1 is a block diagram illustrating an example system architecture 100 deploying reconfigurable processing devices and techniques capable of supporting a diverse set of polynomial-based cryptographic applications, in accordance with one or more aspects of the present disclosure. Example system architecture 100 may be implemented as part of a desktop computer, a tablet, a smartphone, a server (local or remote), a thin/lean client, and/or the like. Example system architecture 100 may be implemented as part of a smart card reader, a wireless sensor node, an embedded system dedicated to one or more specific applications (e.g., cryptographic applications 110), and so on. Example system architecture 100 may include, but need not be limited to, a computer system 102 having one or more processors, e.g., central processing units (CPUs) 120 capable of executing binary instructions, and one or more memory devices, e.g., system memory 130. “Processor” or a “processing device,” as used herein, refers to a device capable of executing instructions encoding arithmetic, logical, or I/O operations. In one illustrative example, a processor may follow the von Neumann architectural model and may include an arithmetic logic unit (ALU), a control unit, and a plurality of registers. In one illustrative example, a processor (e.g., CPU 125) may follow von Neumann architectural model and may include an arithmetic logic unit (ALU), a control unit, and a plurality of registers. In a further aspect, a processor (e.g., CPU 125) may be a single core processor which is typically capable of executing one instruction at a time (or process a single pipeline of instructions), or a multi-core processor which may simultaneously execute multiple instructions. In another aspect, a processor (e.g., CPU 125) may be implemented as a single integrated circuit, two or more integrated circuits, or may be a component of a multi-chip module.

Computer system 102 may include an input/output (I/O) interface 104 to facilitate connection of computer system 102 to peripheral hardware devices 106 such as card readers, terminals, printers, scanners, internet-of-things devices, and the like. Computer system 102 may further include a network interface 108 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from computer system 102. Various hardware components of computer system 102 may be connected via a bus 112 which may include its own logic circuits, e.g., a bus interface logic unit.

Computer system 102 may support one or more cryptographic applications, such as an embedded cryptographic application(s) 110-1 and/or external cryptographic application(s) 110-2. The cryptographic applications may be secure authentication applications, public key signature applications, key encapsulation applications, key decapsulation applications, encrypting applications, decrypting applications, secure storage applications, and so on. Some of the external cryptographic application(s) 110-2 may be instantiated on the same computer system 102, e.g., by an operating system (not shown) residing in system memory 130. Some of the external cryptographic application(s) 110-2 may be instantiated by a guest operating system supported by a virtual machine monitor (hypervisor). Some of the external cryptographic application(s) 110-2 may reside on a remote access client device or a remote server (not shown), with computer system 102 providing cryptographic support for the client device and/or the remote server.

CPU 125 may include one or more processor cores having access to a single or multi-level cache and one or more hardware registers. In some implementations, individual processor cores may execute instructions to run a number of hardware threads, also known as logical processors. Various logical processors (or processor cores) may execute instructions of various cryptographic applications, although more than one logical processor (or processor core) may be assigned to a single cryptographic application for parallel processing. A multi-core CPU 125 may simultaneously execute multiple instructions. A single-core CPU 125 may typically execute one instruction at a time (or process a single pipeline of instructions). CPU 125 may be implemented as a single integrated circuit, two or more integrated circuits, or may be a component of a multi-chip module. System memory 130 may refer to a volatile or non-volatile memory and may include a read-only memory (ROM), a random-access memory (RAM), electrically erasable programmable read-only memory (EEPROM), flash memory, flip-flop memory, or any other device capable of storing data. The RAM may be a dynamic RAM (DRAM), synchronous DRAM (SDRAM), a static memory, such as static RAM (SRAM), and/or the like.

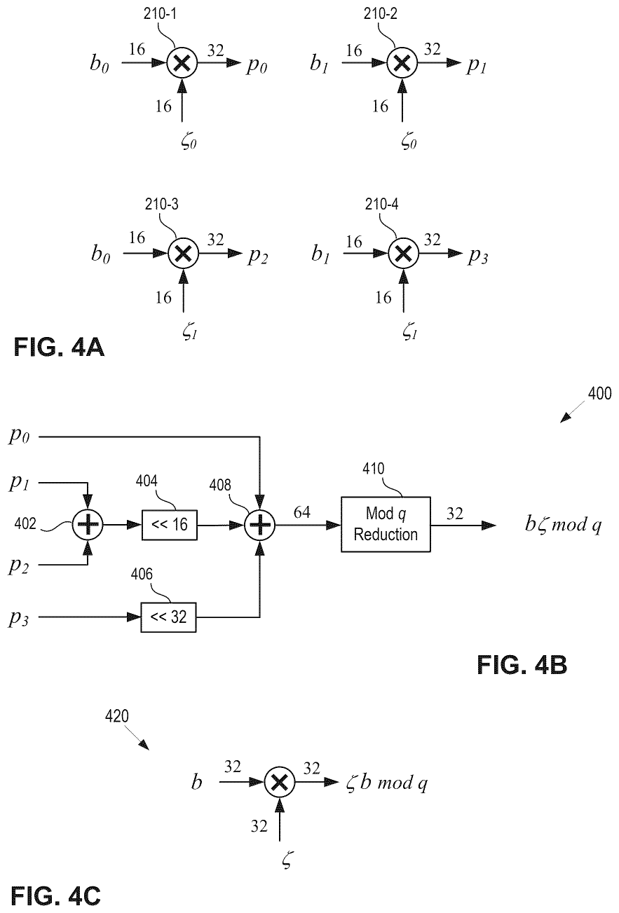

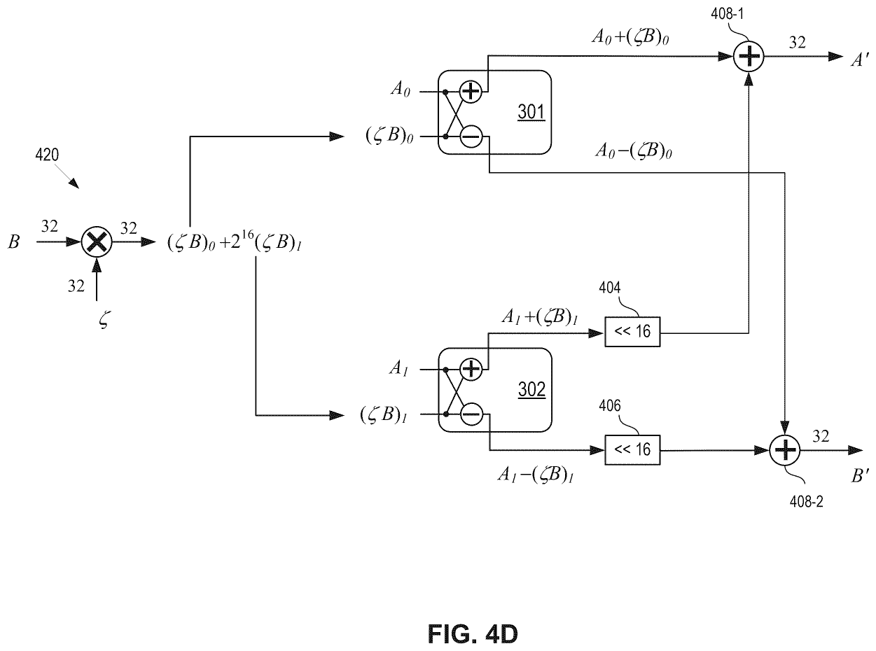

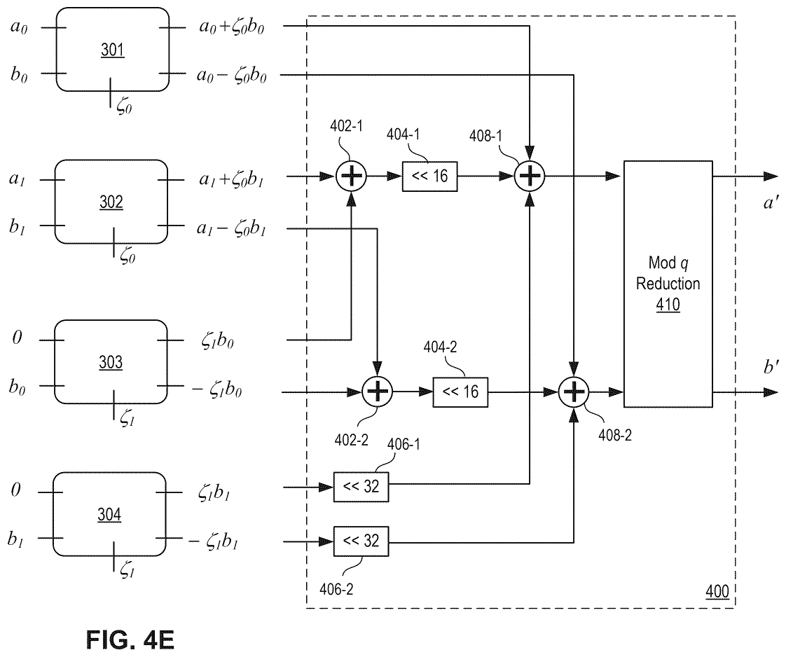

Computer system 102 may include a cryptographic processor 120 implementing various techniques of the present disclosure. Cryptographic processor 120 may include 4× butterfly units 122 that can be selectively reconfigured to implement Cooley-Tukey butterfly operations, Gentleman-Sande butterfly operations, modular multiplications, and/or the like. In some implementations, multiplications may be performed using the Karatsuba algorithm. Butterfly units 122 may be used to compute a forward NTT or a reverse NTT, e.g., in conjunction with the Kyber algorithm, the Dilithium algorithm, and/or other lattice-based algorithms. Architecture of individual butterfly units 122 is disclosed below, e.g., in conjunction with FIGS. 4A-D, and may include multiplication circuits, addition circuits, subtraction circuits, modular reduction circuits, bit shifters, and/or the like. Cryptographic processor 120 may further include a memory unit that includes RAM 124 (e.g., to store data and twiddle factors) and scratchpad memory 126 (e.g., to store intermediate data). In some implementations, RAM 124 may allow retrieving one word (e.g., a 64-bit word or a word of some other size) or storing one word per cycle. Scratchpad memory 126 may allow retrieving one word per cycle and storing one word per cycle. Cryptographic processor 120 may also include a shift register 128. Shift register 128 may facilitate storage and fetching of multiple (e.g., four) 12-bit Kyber polynomial coefficients as different parts of a single 64-bit word stored in scratchpad memory 126. In some implementations, shift register 128 may be a group of memory units (e.g., flip flops) capable of moving (shifting) data between different memory units responsive to applied clock pulses. For example, a 7×64 shift register 128 may be formed by connecting 448 single-bit flip-flops. Shift register 128 may be a shift-left register or a shift-right register. Multiple shift registers 128 may be used, e.g., each shift register supporting operations of a group of 4 butterfly units.

Cryptographic processor 120 may further include a control unit 129 to generate instructions that configure butterfly units 122, scratchpad memory 126, shift register 128, etc., into various configurations supported by cryptographic processor 120 architecture. Control unit 129 may further control operation of cryptographic processor 120 during various cycles of polynomial computations.

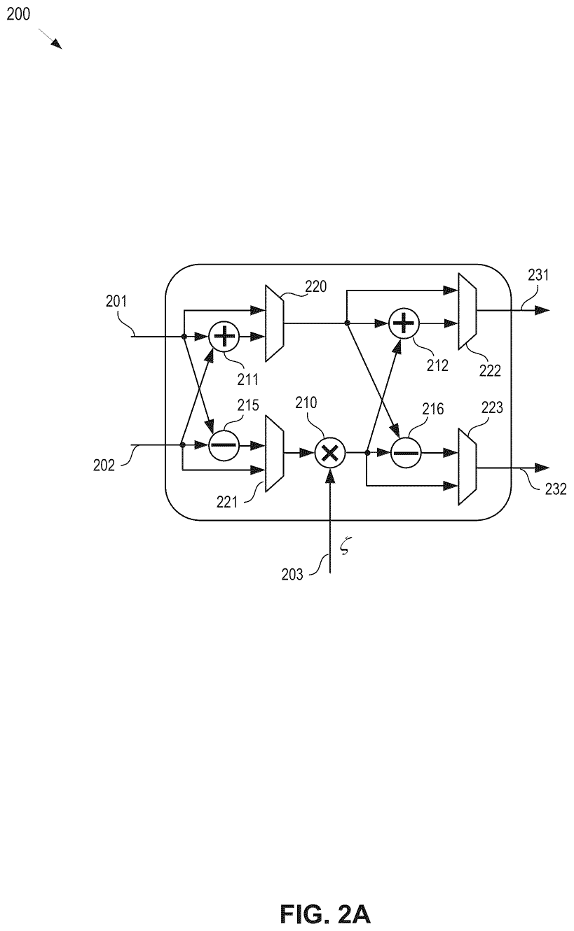

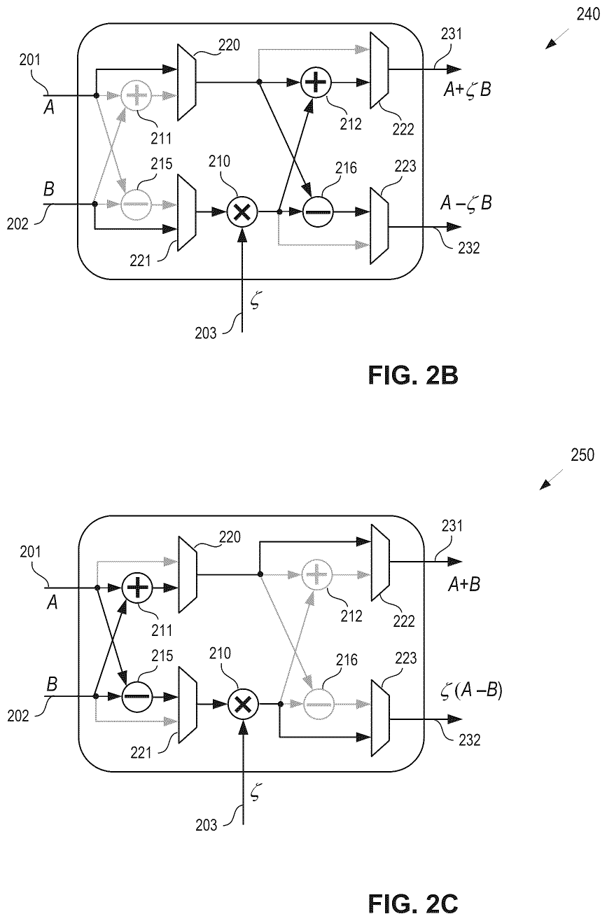

FIGS. 2A-2C depict one example reconfigurable processing unit 200 capable of supporting multiple cryptographic algorithms, in accordance with one or more aspects of the present disclosure. FIG. 2A illustrates an architecture of processing unit 200. As illustrated, in some implementations, processing unit 200 may be a butterfly unit 122 of cryptographic processor 120. In some example implementations, inputs values 201, 202, and 203 into processing unit 200 may be 16-bit numbers, 32-bit numbers, 64-bit numbers, or numbers of any other size. For concreteness, an example implementation of 16-bit input numbers will often be referenced below. Processing unit 200 may include a multiplication circuit 210, addition circuits 211 and 212, and subtraction circuits 215 and 216. Addition circuits 211 and 212 and subtraction circuits 215 and 216 may be modular circuits configured to perform additions and subtractions modulo a set modulus q, e.g., q=13·2⁸+1 when the Kyber algorithm is being implemented, q=2²³−2¹³+1 when the Dilithium algorithm is being implemented, etc. Multiplication circuit 210 may similarly be a modular multiplication circuit that computes products of input numbers for both Kyber and Dilithium, one of 128 different twiddle factors

$${W}_{256}^{i} , i = 0 … 127 ( as {W}_{256}^{i + 128} = - {W}_{256}^{i} mod q ) .$$

To perform modular reduction, multiplication circuit 210 may deploy Montgomery reduction techniques.

Processing unit 200 may further include a plurality of switching devices, e.g., multiplexers 220, 221, 222, and 223. The multiplexers may operate subject to control signals from a control unit (e.g., control unit 129 of FIG. 1) and may selectively transmit any signal (value) that is indicated with an incoming arrow into the corresponding multiplexer, signals output by various addition or subtraction circuit or signals that bypass various addition or subtraction circuits. For example, a first control signal (not shown) into multiplexer 220 may cause multiplexer 220 to pass through the input value 201 whereas a second control signal may cause multiplexer 220 to pass through a value that is a sum of the input value 201 and input value 202. Outputs of multiplexers 222 and 223 may be final outputs of processing unit 200, e.g., output value 231 may be output by multiplexer 222 and output value 232 may be output by multiplexer 223. Additional (e.g., intermediate) outputs of processing unit 200 may also be defined, e.g., using appropriate buses/wires (not shown in FIG. 2A), e.g., as illustrated in conjunction with FIG. 2B and FIG. 2C.

FIG. 2B illustrates configuration 240 and operations of processing unit 200 of FIG. 2A during execution of Cooley-Tukey algorithm of efficient Number Theoretic Transform, in accordance with one or more aspects of the present disclosure. In FIG. 2B (and FIG. 2C) active data path is indicated with black arrows and inactive elements/connections are grayed out. In the Cooley-Tukey configuration 240, control signals applied to multiplexers 220 and 221 cause addition circuit 211 and subtraction circuit 215 to be inactive with multiplexer 220 passing through unmodified input value 201, e.g., a polynomial coefficient A, and multiplexer 221 passing through unmodified input value 202, e.g., a polynomial coefficient B. Multiplication circuit 210 multiplies input value 201 by multiplication input 203, e.g., twiddle factor ζ, to generate the product ζ·B, where ζ may be

$${W}_{N}^{i} , {W}_{256}^{2 br ( i ) + 1} ,$$

or some other value. Addition circuit 212 generates value A+ζ·B, and subtraction circuit 216 generates value A−ζ·B. The generated values are then output as values 231 and 232 by multiplexers 222 and 223, respectively.

A processing device (e.g., cryptographic processor 120) that includes four processing units 200 may perform four Kyber butterfly operations in parallel, e.g., with each processing unit performing a respective butterfly operation on 16-bit Kyber coefficients. The same processing device may perform one Dilithium butterfly operation on 32-bit Dilithium coefficients. More specifically, to compute A+ζ·B and A−ζ·B, each number may be represented via two 16-bit integers, e.g., B=B₀+2¹⁶B₁ and, similarly, ζ=ζ₀+2¹⁶ζ₁. The four butterfly units may compute four products ζ₀. B₀, ζ₀·B₁, ζ₀·B₁ and ζ₁·B₁ and add to/subtract the computed products from appropriate parts A₀ and A₁, e.g., as disclosed in more detail below in conjunction with FIGS. 4A-4D below). Dilithium multiplications (e.g., performed as part of pointwise multiplication of NTT transforms âᵢ\hat{b}ᵢ) may be performed in a similar manner.

FIG. 2C illustrates configuration 250 and operations of processing unit 200 of FIG. 2A during execution of Gentlemen-Sande algorithm of efficient Number Theoretic Transform, in accordance with one or more aspects of the present disclosure. In the Gentlemen-Sande configuration 250, control signals applied to multiplexers 220 and 221 cause addition circuit 211 and subtraction circuit 215 to be active. Addition circuit 211 computes A+B and subtraction circuit computes A−B. Multiplexer 220 and multiplexer 222 (which makes addition circuit 212 inactive) pass the computed value A+B as the output value 231. Multiplexer 221 delivers value A−B to multiplication circuit 210 that multiplies A−B by multiplication input 203, e.g., twiddle factor ζ, to generate the product ζ·(A−B), which is then passed by multiplexer 223 (which makes subtraction circuit 216 inactive) as the output value 232.

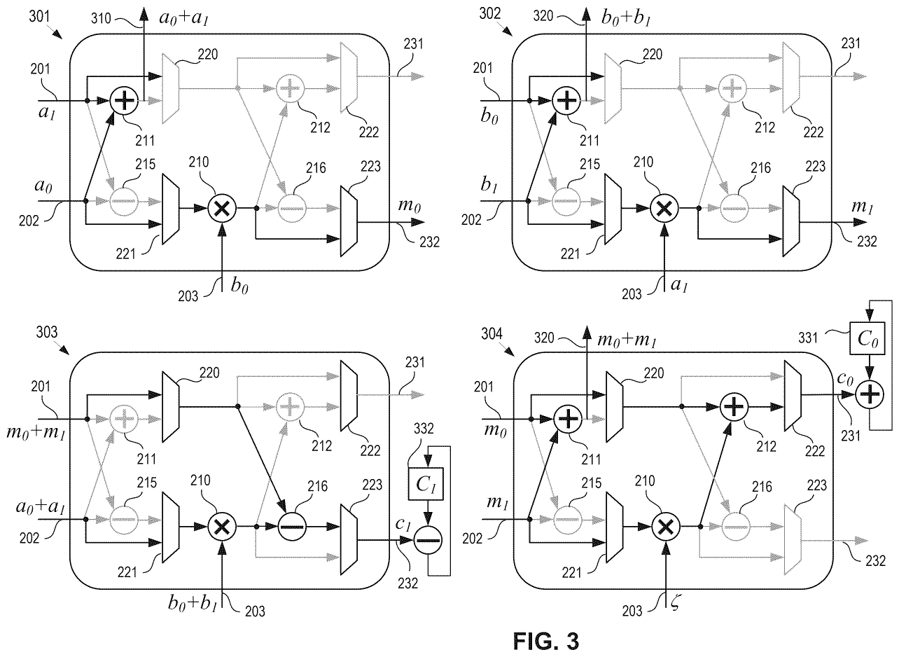

FIG. 3 illustrates deployment of a processing unit for Kyber polynomial multiplication using the Karatsuba algorithm, in accordance with one or more aspects of the present disclosure. The processing unit illustrated in FIG. 3 may be cryptographic processor 120 that includes four butterfly units (e.g., butterfly units 122) numbered as units 301-304. Karatsuba multiplication performed using the butterfly units 301-304 may be a base multiplication, a pairwise-pointwise polynomial multiplication performed as part of the Kyber algorithm, or some other suitable multiplication. For conciseness of notations, inputs delivered over similar wires/buses to various butterfly units 301-304 and various circuits of those butterfly units are denoted with the same numerals. The Karatsuba multiplication is based on the following identity that computes a product of two polynomials a₀+X·a₁ and b₀+X·b₁ using only three multiplications,

$$( {a}_{0} + X \cdot {a}_{1} ) \cdot ( {b}_{0} + X \cdot {b}_{1} ) = {a}_{1} \cdot {b}_{1} \cdot {X}^{2} + [ ( {a}_{0} + {a}_{1} ) \cdot ( {b}_{0} + {b}_{1} ) - {a}_{0} \cdot {b}_{0} - {a}_{1} \cdot {b}_{1} ] \cdot X + {a}_{0} \cdot {b}_{0} ,$$

namely a₀·b₀, a₁·b₁, and (a₀+a₁)·(b₀+b₁), at the cost of a few extra additions and subtractions, which have much lower computational costs than the multiplications. In the case of the Kyber algorithm, the resulting polynomial has to be reduced modulo X²−ζ (e.g., as described above), which amounts to

$$( {a}_{0} + X \cdot {a}_{1} ) \cdot ( {b}_{0} + X \cdot {b}_{1} ) mod ( {X}^{2} - ζ ) = {c}_{0} + X \cdot {c}_{1} = {a}_{0} \cdot {b}_{0} + {a}_{1} \cdot {b}_{1} \cdot ζ + [ ( {a}_{0} + {a}_{1} ) \cdot ( {b}_{0} + {b}_{1} ) - {a}_{0} \cdot {b}_{0} - {a}_{1} \cdot {b}_{1} ] \cdot X ,$$

where the fourth multiplication (of a₁·b₁ by ζ) appears. The four multiplications may be performed by butterfly units 301-304.

More specifically, butterfly unit 301 receives coefficients a₀ and a₁ as input values 202 and 201, respectfully, and uses active addition circuit 211 to compute a₀+a₁, which may then be stored as an intermediate input 310, e.g., in shift register 128. Addition circuit 212 and subtraction circuits 215 and 216 of butterfly unit 301 may be inactive. Furthermore, multiplication circuit 210 receives b₀ as multiplication input 203 and further receives, as the multiplicand, the input value d₀ via multiplexer 221. Multiplication circuit 210 computes the product m₀=a₀·b₀ that is then output by multiplexer 223 as output value 232 of butterfly unit 301.

Butterfly unit 302 receives coefficients b₀ and b₁ as input values 201 and 202, respectfully, and uses active addition circuit 211 to compute b₀+b₁, which may be stored as an intermediate input 320 in shift register 128. Addition circuit 212 and subtraction circuits 215 and 216 of butterfly unit 302 may be inactive. Furthermore, multiplication circuit 210 receives a₁ as multiplication input 203 and further receives, as the multiplicand, the input value b₁ via multiplexer 221. Multiplication circuit 210 computes the product m₁=a₁·b₁ that is then output by multiplexer 223 as output value 232 of butterfly unit 302.

Butterfly unit 303 receives the sum m₀+m₁ as input value 201 and the sum a₀+a₁ as input value 202. Addition circuits 211 and 212 and subtraction circuit 215 of butterfly unit 303 may be inactive. Furthermore, multiplication circuit 210 receives b₀+b₁ as multiplication input 203 and further receives, as the multiplicand, the sum a₀+a₁ via multiplexer 221. Multiplication circuit 210 computes the product (a₀+a₁)·(b₀+b₁). Active subtraction circuit 216 then subtracts this product from the value m₀+m₁. The resulting value a₀·b₀−a₁·b₁−(a₀+a₁)·(b₀+b₁) is stored as coefficient c₁ that is then output by multiplexer 223 as output value 232 of butterfly unit 303.

Butterfly unit 304 receives m₀ as input value 201 and m₁ as input value 202. Subtraction circuits 215 and 216 of butterfly unit 303 may be inactive. Furthermore, multiplication circuit 210 receives a twiddle factor ζ as multiplication input 203 and further receives, as the multiplicand, the value m₁ from multiplexer 221. Multiplication circuit 210 computes the product m₁·ζ=a₁·b₁·ζ. Active addition circuit 212 then adds m₀ to m₁·ζ. The resulting value m₀+m₁·ζ=a₀·b₀+a₁·b₁·ζ is stored as coefficient c₀ that is then output by multiplexer 222 as output value 231 of butterfly unit 304.

In some implementations, output value 231 of butterfly unit 304 may be added to an accumulator value C₀ stored in an accumulator buffer (or register) 331 and then stored back in accumulator buffer 331: c₀+C₀ mod q→C₀. Similarly, output value 232 of butterfly unit 303 may be subtracted from accumulator value C₁ stored in accumulator buffer (or register) 332 and then stored back in accumulator buffer 332: C₁−c₁ mod q→C₁. This effectively stores accumulator polynomial C₀+C₁X across two accumulator buffers 331 and 332. Such accumulated polynomials may be used in various operations of Kyber, Dilithium, and/or other lattice-based polynomial cryptographic algorithms, e.g., in computation of various matrix and vector products (such as products of public matrices of polynomials and secret vectors of polynomials).

Operations of butterfly units 303 and 304 are dependent on the outputs of butterfly units 301 and 302, in particular, on values m₀ and m₁ computed by butterfly units 301 and 302. Therefore, operations of butterfly units 301 and 302, as depicted in FIG. 3, may be performed (in parallel) during a first cycle while operations of butterfly units 303 and 304 may be performed (likewise in parallel) during a second cycle (two-cycle latency). To increase hardware utilization, butterfly units 301-304 may be deployed in an interleaved configuration. More specifically, during the first cycle butterfly units 303 and 304 may compute values m₀′ and m₁′ for a second pair of input polynomials a₀′+X·a₁′ and b₀′+X·b₁′ while butterfly units 301 and 302 may use the computed values m₀′ and m₁′ to compute z₀′ and z₁′ for the second output polynomial. As a result, two sets of output polynomials are computed over two cycles (one-cycle throughput).

Polynomial multiplication illustrated in FIG. 3 may be used for pairwise-pointwise multiplications in the NTT domain. In both instances, the twiddle factors & may be fetched from the same table, e.g., a table stored in RAM 124 in FIG. 1, to reduce the total memory space used. FIG. 3 illustrates performance of 4 multiplications in the course of computation of a product of two polynomials of degree 1 with n-bit (e.g., n=16) coefficients. Similar operations may be performed for multiplication of two 2n-bit numbers, e.g., A[n−1] . . . . A[0] and B[n−1] . . . . B[0] with multiplication of A[n/2−1] . . . . A[0] bits of the first number by B[n/2−1] . . . . B[0] bits of the second number performed by butterfly unit 301, multiplication of A[n−1] . . . . A[n/2−1] bits of the first number by B[n/2−1] . . . . B[0] bits of the second number performed by butterfly unit 302, multiplication of A[n/2−1] . . . . A[0] bits of the first number by B[n−1] . . . . B[n/2−1] bits of the second number performed by butterfly unit 303, and multiplication of A[n−1] . . . . A[n/2−1] bits of the first number by B[n−1] . . . . B[n/2−1] bits of the second number performed by butterfly unit 304.

FIGS. 4A-4C illustrate deployment of the processing unit of FIG. 3 as a Dilithium-type multiplication unit, in accordance with one or more aspects of the present disclosure. The Dilithium-type multiplication unit may operate on 2n-bit input numbers. For concreteness, the case of n=16 is illustrated in FIGS. 4A-4C. More specifically, b=b₀+2¹⁶b₁ and ζ=ζ₀+2¹⁶·ζ₁ are 32-bit inputs into the modular multiplication operation b·ζ mod q, where b₀ represents 16 least significant bits of input b and b₁ represents the next 16 bits of the same input (and, similarly, for the other input ζ). For Dilithium, 9 most significant bits of b₁ and ζ₁ may be used as sign bits (as Dilithium operates on 23-bit numbers), e.g., with the 9 most significant bits having value 0 for negative numbers and value 1 for positive numbers. FIG. 4A depicts schematically operations of multiplication circuits 210-1 . . . 210-4 of the respective butterfly units 301 . . . 304. In particular, multiplication circuit 210-1 computes a partial product p₀=b₀·ζ₀, multiplication circuit 210-2 computes a partial product p₁=b₁·ζ₀, multiplication circuit 210-2 computes a partial product p₂=b₀·ζ₁, and multiplication circuit 210-3 computes a partial product p₃=b₁·ζ₁. Depicted in FIG. 4A (as well as FIG. 4B and FIG. 4C) are bit sizes of processing inputs and outputs. FIG. 4B illustrates an additional processing unit 400, which may be external to the butterfly units 301 . . . 304 and may support post-processing of partial products p₀ . . . p₃. More specifically, addition circuit 402 may compute p₁+p₂ and a 16-bit bit shifter 404 may perform multiplication of p₁+p₂ by 2¹⁶. A 32-bit bit shifter 406 may similarly modify p₃ as follows, p₃→2³²p₃. Addition circuit 408 may then compute b·ζ=2³²p₃+2¹⁶(p₂+p₁)+p₀ and a modulo q reduction circuit 410 may compute b·ζ mod q. In some implementations, reduction circuit 410 may use Montgomery reduction techniques. FIG. 4B illustrates an effective multiplication circuit 420 for computing b·ζ mod q. Operations of butterfly units 301 . . . 304 combined with operations of the additional processing unit 400 are schematically depicted using the effective multiplication circuit 420.

FIG. 4D illustrates one example deployment of the processing units of FIG. 3 for Dilithium NTT butterfly operations, in accordance with one or more aspects of the present disclosure. During performance of the Dilithium NTT, a pair of inputs A and B into a butterfly operation (e.g., A=a₀ and B=a₁₂₈) may be split into two portions, A=A₀+2¹⁶. A₁ and B=B₀+2¹⁶. B₁ representing 16 least significant bits and 16 most significant bits of the two inputs, respectively. As depicted in FIG. 4D, the effective multiplication circuit 420 (implementing operations of FIGS. 4A-4B) computes and combines four 16-bit multiplications ζᵢ·Bⱼ into the 32-bit multiplication ζ·B. Two of the butterfly units, e.g., 301 and 302, may then compute 16-bit additions and subtractions to obtain the low word sums/differences A₀±(ζ·B), and the high word sums/differences A₁±(ζ·B)₁. The high words are bit-shifted using bit-shifters 404 and 406 and then added to the corresponding low words using 32-bit adders 408-1 and 408-2 to produce the final outputs A′=A+ζ·B and B′=A−ζ·B of the butterfly operation. Although Cooley-Tukey butterfly operations are illustrated in FIG. 4D, similar operations may be performed to implement Gentleman-Sande butterflies.

FIG. 4E illustrates another example deployment of the processing units of FIG. 3 for Dilithium NTT butterfly operations, in accordance with one or more aspects of the present disclosure. More specifically, the Cooley-Tukey butterfly operations may be performed as follows,

$${A}^{′} , {B}^{′} = A \pm ζ \cdot B mod q = {A}_{0} \pm {ζ}_{0} \cdot {B}_{0} + ( {A}_{1} \pm {ζ}_{0} \cdot {B}_{1} \pm {ζ}_{1} \cdot {B}_{0} ) \cdot {2}^{16} \pm {ζ}_{1} \cdot {B}_{1} \cdot {2}^{32} mod q .$$

As shown in FIG. 4D, the four multiplications in this expression may be performed by the four butterfly units 301-304 in the Cooley-Tukey configuration 240, followed by the use of the additional processing unit 400. Addition circuits 402-1 and 402-1 may compute the combination A₁+ζ₀·B₁+ζ₁·B₀ and bit-shifters 404-1, 404-2, 406-1, and 406-2 and addition circuits 408-1 and 408-2 may obtain the sums A±ζ·B. Modulo q reduction circuit 410 may then compute the final outputs A′, B′ of the butterfly operation. Similar operations may be performed to implement Gentleman-Sande butterfly operations with the butterfly units 301-304 being in the respective configuration 250.

For implementation of NTTs, multiple iterations (rounds) of NTT may be grouped together, to facilitate more efficient memory utilization, e.g., reduction in the number of memory reads and writes. For example, operations of two NTT iterations may be performed as a single fused group. Kyber and Dilithium, however, deploy NTTs with different numbers of iterations, with Kyber using 7 iterations and Dilithium using 8 iterations. Performing Kyber using three fused groups of 2 iterations leaves one iteration to be performed separately. This results in a memory use inefficiency. Accordingly, to address this inefficiency, the disclosed techniques enable selectively fusing two or three NTT iterations, as may be useful, without storing intermediate outputs. FIG. 5A illustrates operations 500 of three first Cooley-Tukey NTT iterations applied to a portion having eight elements A . . . H, in accordance with one or more aspects of the present disclosure. During a first (2-point) iteration 510, butterfly operations include computing

$${A}^{′} = A + {W}_{128}^{0} \cdot B , {B}^{′} = A - {W}_{128}^{0} \cdot B ,$$

and similarly for other pairs, C and D, E and F, G and H, etc. Twiddle factors used with various elements are indicated next to the respective elements with solid lines indicating that the twiddle factors are taken with a positive sign and dashed lines indicating that the twiddle factors are taken with the negative sign. Similar operations are performed for subsequent iterations. For example, B′ and D′ intermediate values of the second (4-point) iteration 520 are computed according to

$${B}^{″} = {B}^{′} + {W}_{128}^{2} \cdot {D}^{′} , {D}^{″} = {B}^{′} - {W}_{128}^{2} \cdot {D}^{′} ,$$

and D′″ and H′″ output values of the third (8-point) iteration 530 may be computed according to

$${D}^{′′′} = {D}^{″} + {W}_{128}^{3} \cdot {H}^{″} , {H}^{′′′} = {D}^{″} - {W}_{128}^{3} \cdot {H}^{″} .$$

TABLE 1 illustrates read, compute, and write operations as part of a two-iteration fused processing.

TABLE 1
Read, compute, and write operations of
two-iteration fused NTT processing.

| Cycle | Read | Compute | Write |
|---|---|---|---|
| 0 | A | . . . | . . . |
| 1 | B | . . . | . . . |
| 2 | C | . . . | . . . |
| 3 | D | A, B→A′, B′ | . . . |
| 4 | E | C, D→C′, D′ | . . . |
| 5 | F | A′, C′→A″, C″ | . . . |
| 6 | G | B′, D′→B″, D″ | A″ |
| 7 | H | E, F→E′, F′ | B″ |
| 8 | . . . | G, H→G′, H′ | C″ |
| 9 | . . . | E′, G′→E″, G″ | D″ |

As illustrated, during the first four cycles 0-3, elements A, B, C, and D are read from memory, e.g., scratchpad memory 126. Although not shown explicitly for brevity and conciseness, in Kyber implementations, each of the 64-bit elements A, B . . . may include four 16-bit polynomial coefficients, such that the total number of elements A, B . . . may be 256/4=64. During cycles 3-4, butterfly operations for input elements A, B, C, and D of the first iteration are performed, e.g., as disclosed above in conjunction with FIGS. 2B-2C, FIG. 3, and/or FIG. 4, with the four butterfly units 301 . . . 304 performing butterfly operations on eight coefficients at each cycle and generating eight transformed polynomial coefficients. For example, NTT computations A, B→A′, B′ of cycle 3 operate on four coefficients of element A and four coefficients of element B to generate four coefficients of the transformed element A′ and four coefficients of the transformed element B′. During the next two cycles 5-6, butterfly operations of the second iteration for the same input elements are computed. The outputs A″, B″, C″, and D″ are stored, e.g., in the scratchpad memory, during cycles 6-9. In parallel, during cycles 4-7, the next four elements E, F, G, and H are read from the scratchpad memory, the compute and store operations are continued for the elements E, F, G, and H, and so on, until all elements are processed.

TABLE 2 illustrates read, compute, and write operations as part of a three-iteration fused processing. FIG. 5B depicts schematically the last three iterations 501 of Kyber NTT (or inverse NTT) for which the operations of the three-iteration fused processing illustrated in TABLE 2 may be used, in accordance with one or more aspects of the present disclosure. FIG. 5B illustrates operations of the (fifth) 32-point iteration 540, the (sixth) 64-point iteration 550, and the last (seventh) 128-point iteration 560 of Kyber NTT. For brevity, twiddle factors are not listed in FIG. 5B. As before, each element A, B . . . may include four polynomial coefficients operated on by four butterfly units in parallel. The four polynomial coefficients of different elements (and operations therewith) are illustrated schematically for the 128-point iteration 560.

TABLE 2
Read, compute, and write operations of
three-iteration fused NTT processing.

| Cycle | Read | Compute | Write |
|---|---|---|---|
| 0 | A | . . . | . . . |
| 1 | B | . . . | . . . |
| 2 | C | . . . | . . . |
| 3 | D | A, B→A′, B′ | . . . |
| 4 | idle | C, D→C′, D′ | . . . |
| 5 | idle | A′, C′→A″, C″ | . . . |
| 6 | E | B′, D′→B″, D″ | idle |
| 7 | F | A″→A″′, B″→B″′ | idle |
| 8 | G | C″→ C″′, D″→D″′ | A″′ |
| 9 | H | E, F→E′, F′ | B″′ |
| 10 | idle | G, H→G′, H′ | C″′ |
| 11 | idle | E′, G′→E″, G″ | D″′ |
| 12 | . . . | F′, H′→F″, H″ | idle |
| 13 | . . . | E″→E″′, F″→F″′ | idle |
| 14 | . . . | G″ G″′, H″→H″′ | E″′ |

As illustrated in TABLE 2, during the first four cycles 0-3, elements A, B, C, and D may be read from the scratchpad memory. During cycles 3-4, butterfly operations for input elements A, B, C, and D of the fifth 32-point iteration 540 are performed to compute the transformed elements A′, B′, C′, and D′, with the four butterfly units 301 . . . 304 performing butterfly operations on four polynomial coefficients of A and four polynomial coefficients of B. Similarly, during cycles 5-6, butterfly operations for input elements A′, B′, C′, and D′ of the sixth 64-point iteration 550 are performed to compute the elements A″, B″, C″, and D″. As the elements computed are yet to undergo the last processing iteration, no new elements are read during two cycles (e.g., cycles 4-5, as shown) and no final elements are stored for two cycles (e.g., cycles 6-7, as shown). During cycles 7-8, the butterfly units execute computations of the seventh 128-point iteration 560 by performing butterfly operations within each element A″, B″, C″, and D″ (as depicted schematically in FIG. 5B for the 128-point iteration 560). For example, butterfly operations performed for the first pair of element A″ may generate the final NTT polynomial coefficients ã₀ and â₂ while butterfly operations performed for the second pair of element A″ may generate the final NTT polynomial coefficients â₆₄ and â₆₆, the four coefficients â₀, â₂, â₆₄, and â₆₆ constituting the final element A′″ (as part of computation of the even half {â₂₁} of the Kyber NTT). The grouping of coefficients used in this example is given for illustration only, as many other groupings of coefficients into elements may be used. The final outputs A′″, B″, C′″, and D′″ may then be stored in the scratchpad memory during cycles 8-11. In parallel, during cycles 9-14, butterfly operations of the three cycles are performed for the next four elements E, F, G, and H and the coefficients of the final transformed elements E″, F″, G′″, and H″ are stored beginning in cycle 14. In parallel, further elements of the NTT are fetched, operated on, and stored until all elements are processed. Operations of the inverse NTT may be performed similarly (e.g., using the Gentleman-Sande algorithm) to the operations illustrated in TABLE 1 and TABLE 2, with the first four iterations merged into pairs of iterations of TABLE 1 and the last three equations fused as illustrated in TABLE 2. Although in the above example, the last three iterations of Kyber are fused together, iterations 1-3 or iterations 3-5 may be so fused.

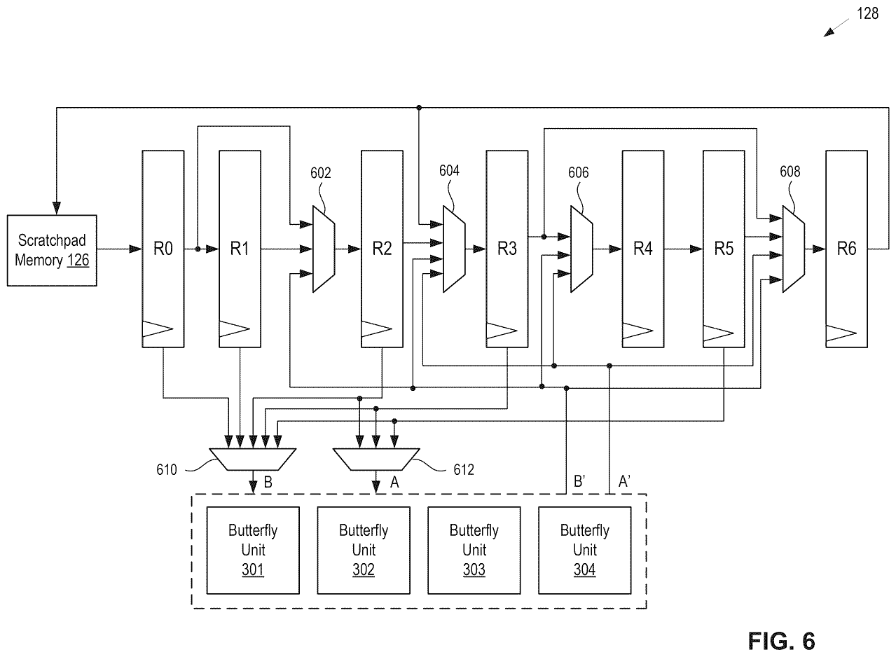

Read/write operations referenced in TABLE 1 and TABLE 2 may be performed using scratchpad memory 126. Prior to storing the computed values in scratchpad memory 126, intermediate values may be stored in shift register 128. FIG. 6 illustrates one example architecture of a shift register 128 that may be used to support operations of butterfly processing units, in accordance with one or more aspects of the present disclosure. As illustrated, shift register 128 may include multiple registers R0 . . . R6, which may be 64-bit registers, each register capable of holding 4 Kyber polynomial coefficients or 2 Dilithium polynomial coefficients. Responsive to a clock signal, shift register 128 may receive an input word (e.g., 64 bits) from scratchpad memory 126 into register R0 and cycle the content of registers, e.g., in the downstream (rightward) direction, SP□R0□R1□R2□ . . . R6□SP. Routing multiplexers 602, 604, 606, and 610 may cause data moved to registers R2, R3, R4, and R6 to be different from the data received from the respective downstream registers and may include data received from butterfly units 301-304 via one of butterfly units outputs denoted schematically via A′ and B′. Some of the multiplexers may support skipped connections, e.g., multiplexer 602 supports skipped connection between register R0 and register R2 while multiplexer 608 supports skipped connection between register R3 and register R6. Connection buses shown in FIG. 6 are intended as an example. In various implementations, some of the shown connections may be absent while other connections, not shown in FIG. 6, may be present. Multiplexers 610 and 612 may control inputs A and B into butterfly units 301-304. For example, as depicted, input A may be received from registers R2, R3, or R5 and input B may be received from registers R0, R1, R2, R3, or R5.

TABLE 3 illustrates shift register operations during two-iteration fused NTT processing. Operations illustrated in TABLE 3 may be performed in conjunction with fused processing operations of TABLE 1. Shown in TABLE 3 are elements stored in registers R0 . . . R6 and scratchpad memory (SP) during cycles 0-13 that are used to process eight input elements A . . . H fetched from SP. Output elements A″ . . . . H″ are likewise stored in SP during cycles indicated in the last column of TABLE 3. Values in different cells of TABLE 3 indicate elements stored in various registers RX at the end of the respective cycles. Ellipses ( . . . ) indicate operations that may be performed in conjunction with processing of elements other than A . . . H. Underlined values indicate elements that are to be used as inputs into the butterfly units in the next cycle. For example, B and A in cycle 2 indicate that values A and B stored at the end of cycle 2 in registers R2 and R1, respectively, are to be used as inputs into the butterfly units during cycle 3. At the end of cycle 3, the outputs A′ and B′ generated by the butterfly units are stored in registers R4 and R3, respectively. Values in the parenthesis indicate elements that are stored in corresponding registers (from past operations) but not used in any subsequent operations. For example, cycle 3 operations may include receiving element D from SP, shifting element C to register R2, processing elements A and B using the butterfly units, and storing received outputs A′ and B′. Cycle 4 operations may include receiving element E from SP, shifting each of elements A′ and B′ to the next downstream register, processing elements C and D using the butterfly units, and storing received outputs C′ and D′ in registers R3 and R2 respectively. Clock 5 generates final output elements A″ and C″, which are stored in SP during cycle 6 and cycle 8, respectively. Other operations are also performed in the order consistent with TABLE 1.

TABLE 3
Shift register operations during two-
iteration fused NTT processing.

| Cycle | R0 | R1 | R2 | R3 | R4 | R5 | R6 | SP |
|---|---|---|---|---|---|---|---|---|
| 0 | A | . . . | . . . | . . . | . . . | . . . | . . . | . . . |
| 1 | B | A | . . . | . . . | . . . | . . . | . . . | . . . |
| 2 | C | B | A | . . . | . . . | . . . | . . . | . . . |
| 3 | D | (B) | C | B′ | A′ | . . . | . . . | . . . |
| 4 | E | (D) | D′ | C′ | B′ | A′ | . . . | . . . |
| 5 | F | E | (D) | D′ | C″ | B′ | A″ | . . . |
| 6 | G | F | E | (D) | D″ | C″ | B″ | A″ |
| 7 | H | (F) | G | F′ | E′ | D″ | C″ | B″ |
| 8 | . . . | (H) | H′ | G′ | F′ | E′ | D″ | C″ |
| 9 | . . . | . . . | (H) | H′ | G″ | F′ | E″ | D″ |
| 10 | . . . | . . . | . . . | (H) | H″ | G″ | F″ | E″ |
| 11 | . . . | . . . | . . . | . . . | . . . | H″ | G″ | F″ |
| 12 | . . . | . . . | . . . | . . . | . . . | . . . | H″ | G″ |
| 13 | . . . | . . . | . . . | . . . | . . . | . . . | . . . | H″ |

TABLE 4 illustrates shift register operations during three-iteration fused NTT processing. Operations illustrated in TABLE 4 may be performed in conjunction with fused processing operations of TABLE 2. Shown in TABLE 4 are elements stored in registers R0 . . . R6 and SP during cycles 0-17 that are used to process eight input elements A . . . H fetched from SP and store output elements A″ . . . . H″ in SP. Ellipses ( . . . ) indicate values that may be stored in conjunction with processing of other elements; empty cells may be associated with idling SP cycles (cycles with no SP reads or writes). Other notations of TABLE 4 are similar to those of TABLE 3.

TABLE 4
illustrates shift register operations during
three-iteration fused NTT processing.

| Cycle | R0 | R1 | R2 | R3 | R4 | R5 | R6 | To SP |
|---|---|---|---|---|---|---|---|---|
| 0 | A | . . . | . . . | . . . | . . . | . . . | . . . | . . . |
| 1 | B | A | . . . | . . . | . . . | . . . | . . . | . . . |
| 2 | C | B | A | . . . | . . . | . . . | . . . | . . . |
| 3 | D | (B) | C | B′ | A′ | . . . | . . . | . . . |
| 4 | | C′ | D′ | A′ | B′ | | . . . | . . . |
| 5 | | | C″ | D′ | A″ | B′ | . . . | . . . |
| 6 | E | | D″ | C″ | B″ | A″ | . . . | |
| 7 | F | E | | D″ | C″′ | B″ | A″′ | |
| 8 | G | F | E | | D″′ | C″′ | B″′ | A″′ |
| 9 | H | (F) | G | F′ | E′ | D″′ | C″′ | B″′ |
| 10 | | G′ | H′ | E′ | F′ | | D″′ | C″′ |
| 11 | | . . . | G″ | H′ | E″ | F′ | | D″′ |
| 12 | . . . | . . . | H″ | G″ | F″ | E″ | | |
| 13 | . . . | . . . | . . . | H″ | G″′ | F″ | E″′ | |
| 14 | . . . | . . . | . . . | . . . | H″′ | G″′ | F″′ | E″′ |
| 15 | . . . | . . . | . . . | . . . | . . . | H″′ | G″′ | F″′ |
| 16 | . . . | . . . | . . . | . . . | . . . | . . . | H″′ | G″′ |
| 17 | . . . | . . . | . . . | . . . | . . . | . . . | . . . | H″′ |

The number of registers (seven) shown in FIG. 6 ensures full utilization of butterfly units and memory during implementation of the Kyber algorithm. The Dilithium algorithm may be implemented using four registers, e.g., registers R0, R2, R3, and R6 (which makes use of the skipped connection from register R3) as well as multiplexers 602, 604, 608, 610, and 612. In various implementations, the number of registers in the shift register may be more than seven or less than seven.

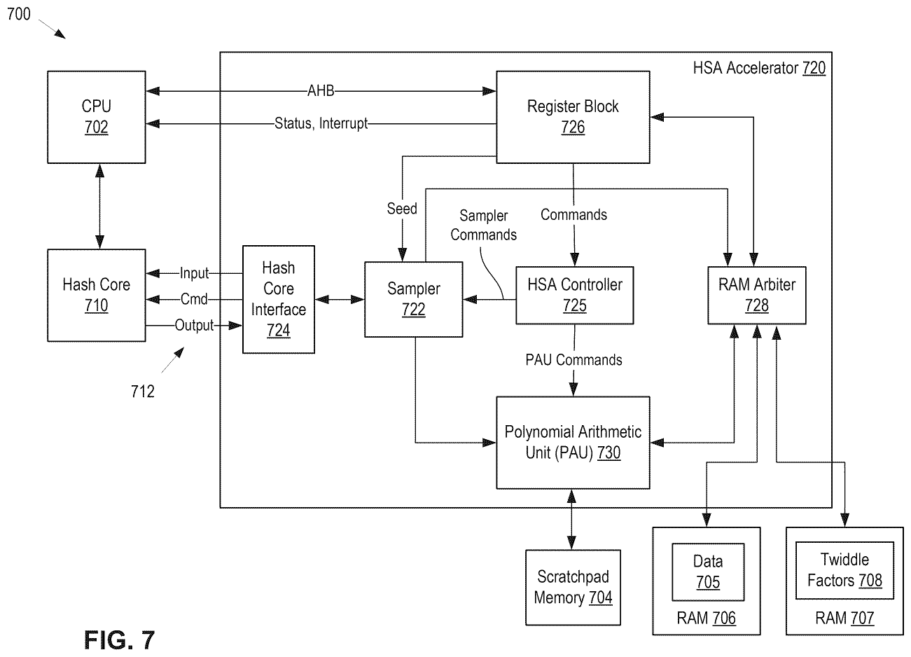

FIG. 7 depicts an example architecture 700 for streaming support of hash acceleration in lattice-based algorithms, in accordance with one or more aspects of the present disclosure. Coefficients of various (public key, randomization, error, etc.) polynomials for Kyber, Dilithium, FrodoKEM, and/or other lattice-based post-quantum cryptographic applications are typically randomly generated using SHAKE-128 hash function, SHAKE-256 hash function, etc., and/or other suitable hash function associated with a Secure Hash Algorithm, e.g., SHA-3 or a similar algorithm. The hash function outputs, however, may have to be pre-processed before being used as polynomial coefficients. The Kyber algorithm may use a large matrix A as part of a public key that is multiplied by a secret vector key s followed by an addition of an error vector e to form a polynomial t=As+e that is used to encrypt a secret message. Matrix A, however, may be too large to efficiently store in memory of many devices and may instead be efficiently sampled using a stream of pseudorandom values generated by a hash function based on a random seed, e.g., a 256-bit seed. Matrix A may be sampled from a uniform distribution while secret vector s and error vector e may be sampled from a binomial distribution. Sampling of the polynomial coefficients may be performed using a rejection sampling algorithm applied to double-byte (16-bit) pairs of values. Both Kyber and Dilithium require a large number of such polynomials, each polynomial having a large number of coefficients. This makes hardware acceleration of hash functions advantageous for achieving high performance. Additional operations that may be hardware-accelerated include sampling and polynomial arithmetic operations. However, for maximizing the overall performance of post-quantum applications and reducing hardware costs, operations of these and other hardware components have to be well coordinated.

As illustrated in FIG. 7, an example streaming architecture 700 for Hash-Sample-Arithmetic (HSA) hardware acceleration of operations of post-quantum algorithms may include a hash core 710 to generate a stream of pseudorandom values and a HSA accelerator 720. In streaming architecture 700 various components may operate in a pipelined fashion to improve utilization across different components and support data streams that do not require large memory buffers. This improves efficiency of memory utilization and reduces the memory bandwidth. High-performance streaming architecture 700 is fully reconfigurable, supports multiple sampling algorithms, and deploys a reconfigurable polynomial arithmetic unit 730, e.g., as disclosed in conjunction with FIGS. 1-6. Streaming architecture 700 supports polynomial operations of multiple post-quantum cryptographic algorithms, e.g., Kyber, Dilithium, FrodoKEM, and/or the like. Polynomial arithmetic unit (PAU) 730 may accelerate performance of multiple polynomial operations, including but not limited to, butterfly operations of NTTs and/or inverse NTTs, pointwise polynomial multiplication (e.g., in the instance of Dilithium), pairwise-pointwise polynomial multiplication (e.g., in the instance of Kyber), efficient polynomial and modular multiplication using the Karatsuba algorithms, modular reduction, and/or other polynomial, integer, and/or modular arithmetic operations. Streaming architecture 700 may include a processor, e.g., CPU 702, that executes any suitable cryptographic application deploying cryptographic protection techniques facilitated by HSA accelerator 720. CPU 702 may control and coordinate a sequence of operations of HSA accelerator 720 using instructions communicated over advanced high-performance bus (AHB) via a register block 726. Streaming architecture 700 may include a scratchpad memory 704 and one or more RAM 706/707. Scratchpad memory 704 may be a dual-port memory device capable of supporting one read and one write operation per one clock cycle. RAM 706/707 may be single-port memory devices capable of supporting one read or one write operation per one clock cycle. Multiple RAM devices may be deployed using RAM arbiter 728, e.g., with one RAM 706 storing any variable data 705 (e.g., various polynomial coefficients) and another RAM 707 storing twiddle factors 708 (and/or any other constant data). In some implementations, twiddle factors 708 may be stored in a read-only-memory (not shown in FIG. 7) instead of RAM 707.

Sampler 722 may operate responsive to instructions from an HSA controller 725 and may sample a stream of outputs of hash core 710 received via a hash core interface 724, perform rejection-acceptance sampling, and provide accepted samples (which may be additionally/processed, in some implementations) to PAU 730. Hash core 710 can be or include any hash function circuit to implement the SHAKE-128 function, SHAKE-256 function, and/or any other similar function that supports any suitable pseudo-random function (PRF), extendable output function (XOF), SHA-3 hashing algorithm, and/or the like. A high-performance channel 712 between hash core 710 and HSA accelerator 720 may include an input channel, an output channel, and a command (“Cmd”) channel. More specifically, the input channel may be a single-cycle latency channel communicating inputs into hash core 710, including but not limited to seeds, various nonce values, and/or other data as may be used by a specific hash function implemented by hash core 710. The output channel may deliver the stream of hash values generated by hash core 710, with the rate of hash value transmission matching the processing speed of HSA accelerator 720, and in particular sampler 722 and/or PAU 730. Matching the processing speed of HSA accelerator 720 to the output channel bandwidth ensures that sampler 722 is neither starved for the hash values (this maximizes efficiency of HSA accelerator 720) nor requires an overflow buffering (this reduces memory requirements). The command channel may be used by sampler 722 to select various modes of hash core 710 operations, including but not limited to an initialization mode, an absorb mode, a squeeze mode, and/or the like. Instructions delivered to hash core 710 may include a runtime-configurable output block size (e.g., 16 bits, 32 bits, etc.) of hash values that are delivered via the output channel.

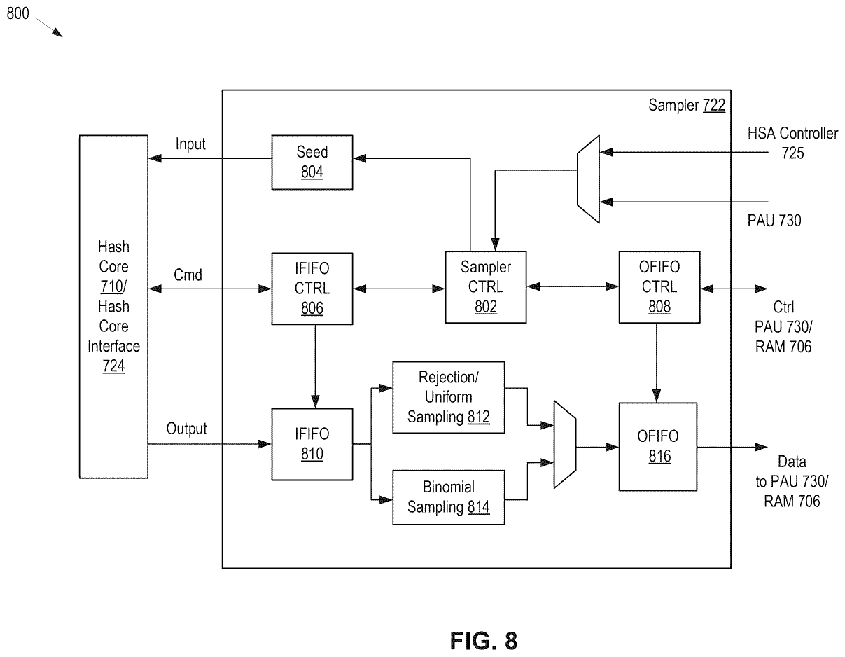

Sampler 722 may implement a configurable data path that supports multiple types of sampling, including but not limited to rejection sampling, uniform sampling, binomial sampling, and/or sampling from any suitable distributions, as may be defined or used in conjunction with any applicable cryptographic algorithm, including but not limited to Kyber, Dilithium, FrodoKEM, and/or other post-quantum algorithms. FIG. 8 depicts an example architecture 800 of sampler 722 of FIG. 7, that supports a configurable data path for acceleration of lattice-based algorithms, in accordance with one or more aspects of the present disclosure. Sampler 722 may include a sampler control circuit 802 to control a sequence of operations of sampler 722 and to synchronize these operations with operations of hash core 710 and/or PAU 730. Sampler 722 may include a seed generator 804 to generate seeds (and/or other nonce values) for hash core 710. Control instructions between hash core 710 and sampler control circuit 802 may be communicated using an input FIFO (first-in-first-out buffer) CTRL 806 while control instructions between sampler control circuit 802 and PAU 730 may be communicated via output FIFO CTRL 808.

Input FIFO 810 and output FIFO 816 may be used to facilitate receiving data (hash value candidates) from hash core 710 and transmitting data (accepted polynomial coefficients) to PAU 730 and/or RAM 706. Some of the data received from hash core 710 may be sampled using rejection/uniform sampling circuit 812 (e.g., public matrix polynomials) whereas other data may be sampled using binomial sampling circuit 814 (e.g., secret vector polynomials, error vector polynomials, and/or the like). In some implementations, various circuits implementing other sampling algorithms, including (but not limited to) sample-in-ball algorithms, can be used in addition to sampling circuits 812 and 814.

Sampler 722 can operate in conjunction with hash core 710 and PAU 730 to implement the Hash-Sample-Arithmetic pipeline and facilitate receiving data from hash core 710, process (sample/reject/accept) the received data and transfer the accepted data to PAU 730. This enables sampler 722 to generating the public matrix A at runtime and PAU 730 to perform polynomial multiplication (and accumulation) without storing matrix A, which significantly reduces memory costs. In some implementations, sampler 722 may function independently of PAU 730 by performing sampling of hash core outputs and storing accepted samples in RAM 706 and/or other memory device(s). This enables parallel operations of sampler 722 and PAU 730 with sampler 722 generating a polynomial while PAU 730 is performing arithmetic operations on another polynomial (e.g., a polynomial generated by sampler 722 during one of previous operations).

In some implementations, HSA controller 725 (or some other control unit) may control a throughput THC of the stream of hash values output by hash core 710 in view of a throughput TPAU of a stream of polynomial coefficients that PAU 730 may consume (process). For example, HSA controller 725 may determine control throughput THC in view of an average rate of rejection R of hash values by sampler 722, e.g., THCR=TPAU. In some implementations, some of the polynomial coefficients produced by sampler 722 may be stored in a memory device (e.g., scratchpad memory 704, RAM 706, etc.). In such implementations, throughput THC may be determined in further view of a throughput TMEM stored the memory device, e.g., THCR=TPAU+TMEM. In some implementations, relying on average rate of rejection R of the hash values by sampler 722 may be insufficient at runtime since some algorithms supported by HSA accelerator 720 may have a rate of rejection that significantly fluctuates around the average rate. In such implementations, HAS controller 725 may monitor an input buffer of sampler 722 (e.g., IFIFO 810 in FIG. 8) and request hash values from hash core 710 when the input buffer is not full. PAU 730 may fetch samples from an output buffer of sampler 722 (e.g., OFIFO 816 in FIG. 8) when is not empty. This ensures a continuous stream of samples to support operations of PAU 730 except for rare occurrences when sampler 722 rejects an above-average percentage of incoming hash values for a substantial continuous time despite the input buffer being completely (or almost completely) full and the output buffer being completely (or almost completely) empty.

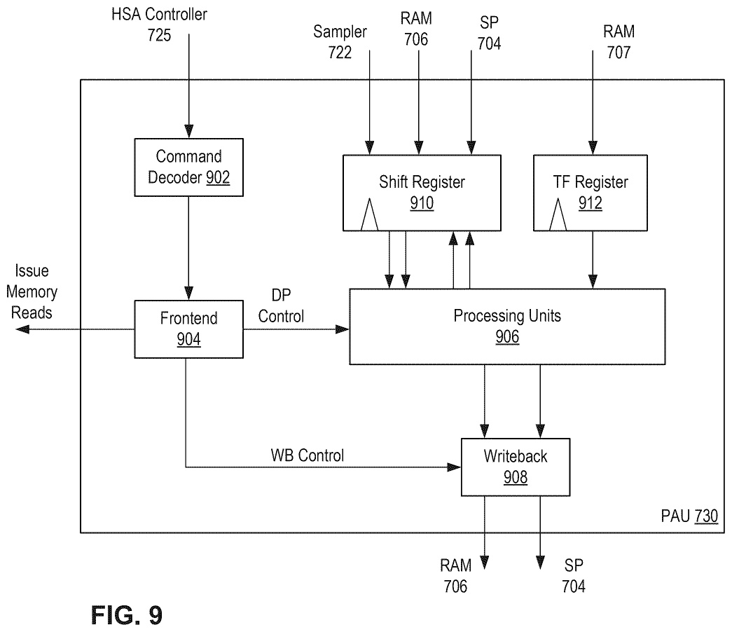

FIG. 9 illustrates an example architecture of PAU 730 that supports, as part of a Hash-Sample-Arithmetic pipeline, a configurable data path for acceleration of lattice-based algorithms, in accordance with one or more aspects of the present disclosure. PAU 730 may include a command decoder 902 to receive commands from HSA controller 725 and pass the decoded commands to frontend circuit 904, which may issue memory reads, digital processor (DP) control instructions to processing units 906, and writeback instructions to a write back circuit 908. Processing units 906 may include four or more butterfly units (e.g., butterfly units 301 . . . 304 of FIG. 3) operating as disclosed in conjunction with FIG. 2-5. Processing units 906 may exchange data with a shift register 910 (which may be shift register 128), e.g., receive input and/or intermediate polynomial coefficients from shift register 910 and store intermediate and/or output polynomial coefficients in shift register 910. Random polynomial coefficients may be loaded into shift register 910 from sampler 722 (e.g., as disclosed above in conjunction with FIGS. 7-8), while stored data values may be loaded from RAM 706 and/or scratchpad (SP) 704. Twiddle factors may be loaded from RAM 707 into TF register 912, which may deliver various twiddle factors to processing units 906, as appropriate for a given iteration/cycle. Writeback circuit 908 may store (responsive to frontend circuit 904 commands) computational outputs generated by processing units 906 back into RAM 706 and/or SP 704.

As described in conjunction with FIGS. 1-6, PAU 730 (or a similar processing device) may support various modular and integer arithmetic operations that may be used by post-quantum algorithms, including NTT, inverse NTT, and polynomial multiplication operations. PAU 730 may be a fully reconfigurable device that allows fully utilizing reconfigurability of processing units 906. For example, every four of processing units 906 may be configured to process (in parallel) four Kyber butterfly operations or one Dilithium butterfly operation. Processing units 906 may be configured to perform Cooley-Tukey and/or Gentleman-Sande butterfly operations to support efficient NTT and/or inverse NTT operations.

Every four processing units 906 may be configured to perform four modular multiplications, e.g., using the Karatsuba multiplication, for pairwise-pointwise polynomial Kyber multiplication and accumulation, or one modular multiplication for pointwise polynomial Dilithium multiplication. Processing units 906 may be capable of fusing two and/or three NTT iterations (layers) of Kyber NTT and/or inverse NTT operations to reduce an amount of memory reads and writes. Processing units 906 may include a special prime reduction unit for Montgomery multiplications.

The HSA accelerator 720, sampler 722, and PAU 730 can be configured to support vector and matrix computations, including (but not limited to) vector and matrix computations involving integer polynomials, e.g., as used in Kyber and Dilithium algorithms.

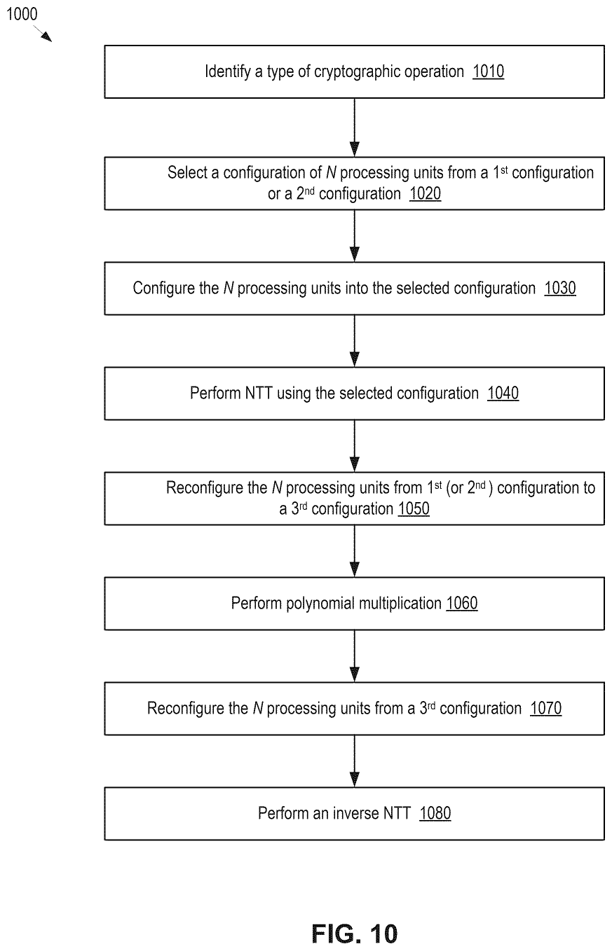

FIG. 10 depicts a flow diagram of an example method 1000 of deploying reconfigurable processing units, operating in accordance with one or more aspects of the present disclosure, for performance of polynomial-based cryptographic applications. Method 1000 and/or each of its individual functions, routines, subroutines, or operations may be performed by a suitable cryptographic accelerator (engine), such as cryptographic processor 120 of FIG. 1, PAU 730 of FIG. 7, and/or any other similar processing device. Various blocks of method 1000 may be performed in a different order compared with the order shown in FIG. 10. Some operations of method 1000 may be performed concurrently with other operations. Some operations may be optional. In some implementations, at least some operations of method 1000 may be performed in parallel, each parallel thread executing one or more individual functions, routines, subroutines, or operations of the methods. In some implementations, parallel threads implementing method 1000 may be synchronized (e.g., using semaphores, critical sections, and/or other thread synchronization mechanisms). Alternatively, threads implementing method 1000 may be executed asynchronously with respect to each other. Various operations of method 1000 may be performed in a different order compared with the order shown in FIG. 10. Some operations of method 1000 may be performed concurrently with other operations. In some implementations of method 1000, one or more operations shown in FIG. 10 are not performed.

At block 1010, method 1000 may include identifying a type of a cryptographic operation being performed. In some implementations, identification of the type of cryptographic operation may be performed by a general-purpose processor (such as a CPU, application-specific integrated circuit (ASIC), and/or the like), based on a specific application supported by the cryptographic operations of method 1000. The cryptographic operation may include a Number Theoretic Transform (NTT) of a plurality of coefficients.

At block 1020, method 1000 may include selecting, in view of the identified type of the cryptographic operation, one of a plurality of configurations of N processing units. In some implementations N processing units may include 4× sets of butterfly units 301 . . . 304 disclosed in conjunction with FIGS. 2-4. In some implementations, in a first configuration of the plurality configurations, the N processing units are to jointly perform a butterfly operation on two coefficients of the plurality of coefficients, each of the two coefficients having a first bit size. For example, the first bit size may be 32 bits (e.g., for an application that uses the Dilithium algorithm). In some implementations, in a second configuration of the plurality configurations, the N processing units are to perform (in parallel) N butterfly operations, each of the N butterfly operations may be performed on a pair of coefficients of the plurality of coefficients, each of the pair of coefficients having a second bit size. For example, the second bit size may be 16 bits (e.g., for an application that uses the Kyber algorithm). In some implementations, in the first configuration, the N processing units may be performing a 256-point Dilithium NTT while in the second configuration, the N processing units may be performing two 128-point Kyber NTTs.

At block 1030, method 1000 may include configuring the N processing units into the selected configuration and, at block 1040, using the selected configuration to perform the NTT of the plurality of coefficients (e.g., the Dilithium NTT in the first configuration or the Kyber NTT in the second configuration).

At block 1050, method 1000 may continue with, responsive to completion of the NTT, reconfiguring the N processing units to a new configuration. For example, in Dilithium applications, reconfiguration may be from the first configuration to a configuration in which the N processing units are to perform modular multiplications of numbers of the first bit size. In another example, in Kyber applications, reconfiguration may be from the second configuration to a configuration in which the N processing units are to perform one or more modular polynomial multiplications of degree-one polynomials having coefficients of the second bit size. In some implementations, the one or more modular polynomial multiplications may be performed using a Karatsuba multiplication algorithm.

At block 1060, method 1000 may include performing polynomial multiplication, e.g., Dilithium pointwise (element-by-element) polynomial multiplication or Kyber pairwise-pointwise (pair of elements by pair of elements) polynomial multiplication.

At block 1070, method 1000 may continue with reconfiguring the N processing units into a different configuration to perform, at block 1080, an inverse NTT. For example, while the first configuration or the second configuration (used for the computation of the NTT at block 1040) may use a Cooley-Tukey setup (e.g., as illustrated in FIG. 2B), the configuration used for the inverse NTT may use a Gentleman-Sande setup (e.g., as illustrated in FIG. 2C).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A processing device comprising a plurality of 4N configurable processing units, wherein the plurality of 4N configurable processing units is to:
perform a fast discrete transform (FDT) of a plurality of coefficients using a plurality of iterations, wherein each iteration of the FDT comprises a plurality of butterfly operations (BOs), and wherein, in a first configuration of the processing device, the plurality of 4N configurable processing units is to perform three iterations of the FDT for 4N coefficients of the plurality of coefficients using one memory read operation for each of the 4N coefficients.

2. The processing device of claim 1, wherein, in a second configuration of the processing device, the plurality of 4N configurable processing units is to perform two iterations of the FDT for 4N coefficients of the plurality of coefficients using one memory read operation for each of the 4N coefficients.

3. The processing device of claim 1, wherein each BO of the plurality of BOs, performed by a respective processing unit of the plurality of 4N configurable processing units, uses two input values to compute two output values, wherein each of the two output values comprises a weighted combination of the two input values, and wherein at least one of the two input values in the weighted combination is weighted using a root of unity.

4. The processing device of claim 1, wherein the plurality of BOs comprises Cooley-Tukey BOs or Gentleman-Sande BOs.

5. The processing device of claim 1, wherein the FDT comprises one of a fast Number Theoretic Transform (NTT) or a fast Digital Fourier Transform.

6. The processing device of claim 5, wherein the FDT comprises one of:
a Dilithium NTT performed on the plurality of coefficients comprising 256 coefficients, or
a first Kyber NTT performed on a first subset of 128 coefficients of the plurality of coefficients and a second Kyber NTT performed on a second subset of 128 coefficients of the plurality of coefficients.

7. The processing device of claim 1, wherein during a first iteration of the FDT, the plurality of 4N configurable processing units is to:
apply a first set of the plurality of BOs to a first set of the plurality of coefficients and a second set of the plurality of coefficients to compute:
a first intermediate set of coefficients, and
a second intermediate set of coefficients; and
apply a second set of the plurality of BOs to a third set of the plurality of coefficients and a fourth set of the plurality of coefficients to compute:
a third intermediate set of coefficients, and
a fourth intermediate set of coefficients; and
wherein during a second iteration of the FDT, the plurality of 4N configurable processing units is to:
apply a third set of the plurality of BOs to the first intermediate set of coefficients and the third intermediate set of coefficients to compute:
a fifth intermediate set of coefficients, and
a sixth intermediate set of coefficients; and
apply a fourth set of the plurality of BOs to the second intermediate set of coefficients and the fourth intermediate set of coefficients to compute:
a seventh intermediate set of coefficients, and
an eighth intermediate set of coefficients.

8. The processing device of claim 7, wherein the first set of the plurality of coefficients is stored using a contiguous range of memory bits of a memory device.

9. The processing device of claim 8, wherein the contiguous range of memory bits is within a single memory word.

10. The processing device of claim 7, further comprising:
a shift register comprising a plurality of registers, wherein the plurality of registers is to store, after the first iteration of the FDT:
the first intermediate set of coefficients,
the second intermediate set of coefficients,
the third intermediate set of coefficients, and
the fourth intermediate set of coefficients; and
wherein the plurality of registers is to store, after the second iteration of the FDT:
the fifth intermediate set of coefficients,
the sixth intermediate set of coefficients,
the seventh intermediate set of coefficients, and
the eighth intermediate set of coefficients.

11. The processing device of claim 7, wherein during a third iteration of the FDT, the plurality of 4N configurable processing units is to:
apply a fifth set of the plurality of BOs to the fifth intermediate set of coefficients to compute a first output set of coefficients; and
apply a sixth set of the plurality of BOs to the sixth intermediate set of coefficients to compute a second output set of coefficients.

12. The processing device of claim 11, wherein, prior to completion of the third iteration of the FDT, the processing device is to move the first output set of coefficients from a shift register to a memory device, and wherein the memory device comprises a dual-ported device capable of performing, during each cycle, a read operation and a write operation.

13. A processing device comprising a plurality of 4N processing units, wherein in a first configuration, the plurality of 4N processing units is to perform 4N butterfly operations (BOs) of a Kyber Number Theoretic Transform (NTT), each of the 4N BOs being performed on coefficients having a first bit size, and
wherein in a second configuration, the plurality of 4N processing units is to perform N BOs of a Dilithium NTT, each of the N BOs being performed on coefficients having a second bit size, wherein the second bit size is greater than the first bit size.

14. The processing device of claim 13, wherein in a third configuration, the plurality of 4N processing units are to perform a modular polynomial multiplication of degree-one polynomials, wherein coefficients of the degree-one polynomials have the first bit size; and
wherein in a fourth configuration, the plurality of 4N processing units is to perform a modular multiplication of numbers having the second bit size.

15. The processing device of claim 14, wherein in the third configuration, the plurality of 4N processing units are to perform the modular polynomial multiplication of the degree-one polynomials using a Karatsuba multiplication.

16. The processing device of claim 14, wherein each of the plurality of 4N processing units comprises:
a first plurality of addition or subtraction circuits;
a modular multiplication circuit; and
a plurality of multiplexers to:
select an input into the modular multiplication circuit from at least one of:
a plurality of inputs into a respective processing unit, or
an output of at least one of the first plurality of addition or subtraction circuits.

17. The processing device of claim 16, wherein each of the plurality of 4N processing units further comprises:
a second plurality of addition or subtraction circuits;
wherein the plurality of multiplexers is further to:
selectively provide an output of the modular multiplication circuit as at least one of:
an output of the respective processing unit, or
an input into at least one of the second plurality of addition or subtraction circuits.

18. The processing device of claim 17, wherein the numbers comprise a first number and a second number, wherein in the fourth configuration, the processing device is to partition each of the first number and the second number into a plurality of input values of the first bit size, and wherein each of the plurality of 4N processing units is to multiply one of the input values of the first number by one of the input values of the second number to generate a respective partial product of a plurality of partial products.

19. The processing device of claim 18, further comprising:
a plurality of additional circuits to combine the plurality of partial products into a product of the first number and the second number, the plurality of additional circuits comprising:
one or more bit shifters, and
a modular reduction unit.

20. A method to perform a cryptographic operation, the method comprising:
identifying a type of the cryptographic operation, wherein the cryptographic operation comprises a Number Theoretic Transform (NTT) of a plurality of coefficients;
selecting, in view of the identified type of the cryptographic operation, one of a plurality of configurations of N processing units, N being equal to or greater than four,
wherein in a first configuration of the plurality configurations, the N processing units are to jointly perform a butterfly operation (BO) on two coefficients of the plurality of coefficients, each of the two coefficients having a first bit size, and
wherein in a second configuration of the plurality configurations, the N processing units are to perform N BOs, each of the N BOs performed on a pair of coefficients of the plurality of coefficients, each of the pair of coefficients having a second bit size;
configuring the N processing units into the selected configuration; and
performing, using the N processing units, the NTT of the plurality of coefficients.
